(19) United States
(12) Patent Application Publication
(10) Pub. No.: US 2015/0026809 A1
(43) Pub. Date: Jan. 22, 2015

(54) SYSTEMS AND METHODS FOR IDENTIFYING MALICIOUS HOSTS

(71) Applicant: Verint Systems, Ltd., Herzliya Pituach (IL)

(72) Inventors: Yuval Altman, Herzliya (IL); Assaf Yosef Keren, Ramat Gan (IL)

(21) Appl. No.: 14/337,341

(22) Filed: Jul. 22, 2014

(30) Foreign Application Priority Data
Jul. 22, 2013 (IL) 227598

(51) Int. Cl. H04L 29/06

(52) U.S. Cl. CPC H04L 63/1483; H04L 63/145
USPC 726/23

(57) ABSTRACT

A malware detection system analyzes communication traffic to and/or from a certain host. The malware detection system uses the mismatch between host name and IP address to assign a quantitative score, which is indicative of the probability that the host is malicious. The system may use this score, for example, in combination with other indications, to decide whether the host in question is malicious or innocent. The overall decision may use, for example, a rule engine, machine learning techniques or any other suitable means. The malware detection system may also analyze alerts regarding hosts that are suspected of being malicious. The alerts may originate, for example, from Command & Control (C&C) detection, from an Intrusion Detection System (IDS), or from any other suitable source. A given alert typically reports a name of the suspected host and an IP address that allegedly belongs to that host.

### FIELD OF THE DISCLOSURE

The present disclosure relates generally to network security, and particularly to methods and systems for identifying malicious hosts.

### BACKGROUND OF THE DISCLOSURE

Various types of malicious software, such as viruses, worms and Trojan horses, are used for conducting illegitimate operations in computer systems. Malicious software may be used, for example, for causing damage to data or equipment, or for extracting or modifying data. Some types of malicious software communicate with a remote host, for example for Command and Control (C&C) purposes.

Various techniques for detecting malware are known in the art. For example, Bilge et al. describe a system that employs large-scale, passive Domain Name System (DNS) analysis techniques to detect domains that are involved in malicious activity, in “EXPOSURE: Finding Malicious Domains Using Passive DNS Analysis,” Proceedings of the 18^{th} Annual Network and Distributed System Security Symposium (NDSS), San Diego, Calif., February, 2011, which is incorporated herein by reference.

### SUMMARY OF THE DISCLOSURE

An embodiment that is described herein provides a method including receiving network communication, which indicates a name of a host and an alleged network address of the host. Verification is made as to whether the alleged network address is genuinely associated with the host. In response to detecting that the alleged network address is not genuinely associated with the host, a decision is made that the network communication associated with the host is malicious.

In some embodiments, deciding that the network communication is malicious includes assigning to the host a respective quantitative score that is indicative of a probability that the host is malicious. In an embodiment, receiving the network communication includes receiving a request-response transaction that includes the name and the alleged network address of the host. In some embodiments, receiving the network communication includes receiving an alert that suspects the host is malicious, and deciding that the network communication associated with the host is malicious includes reaffirming the alert.

In a disclosed embodiment, the network address includes an Internet Protocol (IP) address. In another embodiment, verifying whether the alleged network address is associated with the host includes checking whether the host and the alleged network address belong to a same Autonomous System (AS). In yet another embodiment, verifying whether the alleged network address is associated with the host includes estimating a first geographical location of the alleged network address and comparing the first geographical location with a second geographical location of the host.

In a disclosed embodiment, verifying whether the alleged network address is associated with the host includes detecting a deviation from an expected flow of an address resolution process for the host. In another embodiment, deciding that the network communication associated with the host is malicious includes outputting an alert to an operator.

There is additionally provided, in accordance with an embodiment that is described herein, an apparatus including an interface and a processor. The interface is configured to receive network communication that indicates a name of a host and an alleged network address of the host. The processor is configured to verify whether the alleged network address is genuinely associated with the host, and, in response to detecting that the alleged network address is not genuinely associated with the host, to decide that the network communication associated with the host is malicious.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates a computer network employing malicious host detection, in accordance with an embodiment that is described herein; and

FIG. 2 is a flow chart that schematically illustrates a method for detecting malicious hosts.

### DETAILED DESCRIPTION OF EMBODIMENTS

### Overview

Embodiments that are described herein provide methods and systems for identifying malicious hosts. A malicious host is defined as a computer whose communication traffic is at least partly malicious. Examples of malicious hosts include hosts that remotely control malicious software (“malware”) installed in attacked computers, or hosts that originate attacks on computers.

In some embodiments, a malware detection system analyzes communication traffic to and/or from a certain host. The traffic typically indicates a name of the host and one or more IP addresses that allegedly belong to that host. The malware detection system attempts to verify whether the alleged IP addresses are genuinely associated with the host. If not, the system concludes that the host in question is likely to be malicious.

The rationale behind this technique is that a mismatch between host name and IP address is highly indicative of malicious traffic. Such a mismatch may be indicative, for example, of traffic that attempts to appear as originating from a well-known and trusted host name, or traffic that alternates IP addresses to evade detection.

In a typical embodiment, the malware detection system uses the mismatch between host name and IP address to assign a quantitative score, which is indicative of the probability that the host is malicious. The system can use this score, for example, in combination with other indications, to decide whether the host in question is malicious or innocent. The overall decision may use, for example, a rule engine, machine learning techniques or any other suitable means.

In another example embodiment, the malware detection system analyzes alerts regarding hosts that are suspected of being malicious. The alerts may originate, for example, from Command & Control (C&C) detection, from an Intrusion Detection System (IDS), or from any other suitable source. A given alert typically reports a name of the suspected host and an IP address that allegedly belongs to that host. In these embodiments, the malware detection system uses the techniques described herein to verify (i.e., reaffirm or contradict) the alerts. This technique is useful, for example, for minimizing false-positives, i.e., false detections of malicious hosts that are actually legitimate.

In various embodiments, the system may use different techniques for finding a discrepancy between host name and IP address. In some embodiments, the system may attempt to find a deviation from the normal flow of the address resolution process that associates the host name with its IP address. For example, the system may search in the network traffic for a Domain Name System (DNS) request that precedes the alert (possibly by hours or more) and requests the IP address of the host. Absence of such a DNS request and response, or appearance of a DNS response with a different IP address, may indicate that the host is malicious.

In other embodiments, the system may verify whether the host and the alleged IP address belong to the same Internet Autonomous System (AS), to verify whether the geographical location of the alleged IP address (obtained using IP geo-location) matches the geographical location of the host, or apply any other suitable method. Using the disclosed techniques, the system is able to increase the quality of malware detection.

### System Description

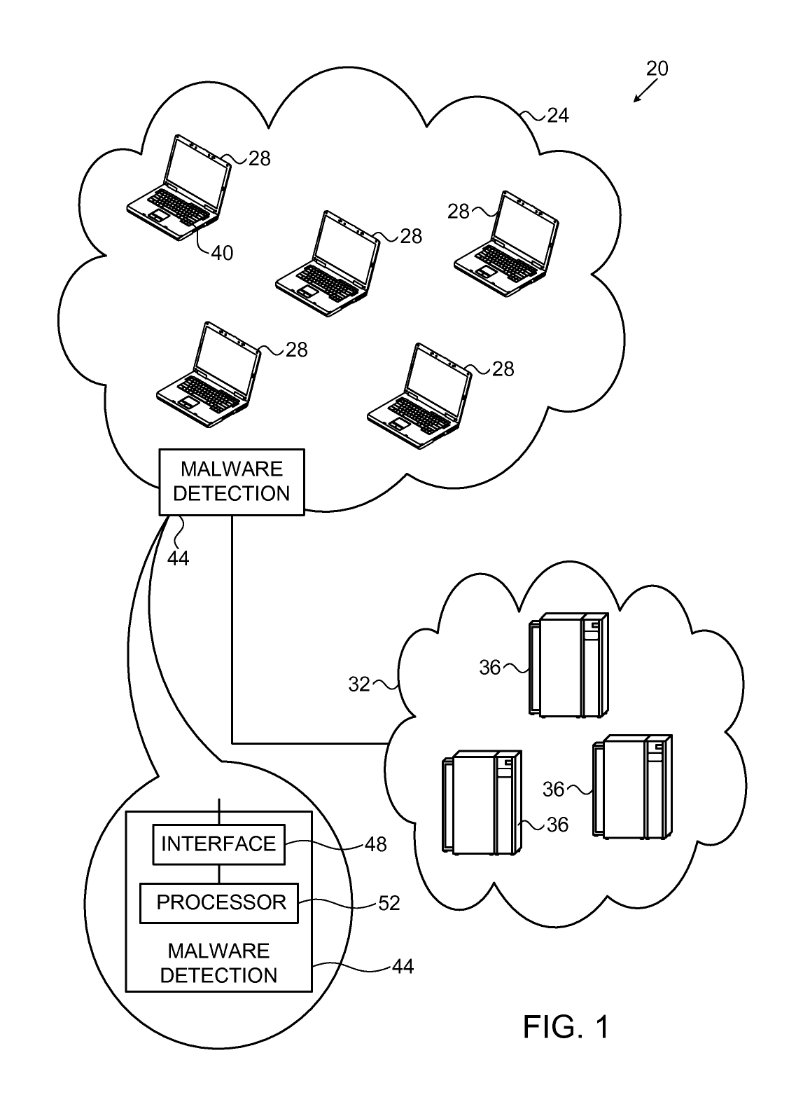

FIG. 1 is a block diagram that schematically illustrates a computer system 20 employing malicious host detection, in accordance with an embodiment that is described herein. The present example shows a protected computer network 24, such as an internal network of an organization. Network 24 comprises multiple computers 28, such as personal computers, workstations, mobile computing or communication devices or virtual machines. Network 24 is connected to a public network 32, such as the Internet. Computers 28 may communicate with one another over network 24, and/or with servers or other computers 36 (collectively referred to as hosts) in network 32. The system configuration of FIG. 1 is shown purely by way of example, and the disclosed techniques can also be used with various other suitable system configurations.

In some scenarios, a certain computer 28 in network 24 may be infected with malicious software 40 (referred to as “malware”), for example a virus, a worm or a Trojan horse. The malware may carry out various kinds of illegitimate actions, for example steal data from the infected computer or otherwise from network 24, modify or damage data, or cause damage to the infected computer or other equipment of network 24.

In some scenarios, malware 40 is controlled by a remote host, e.g., one of hosts 36 in network 28. Communication between the malware and this remote host may be bidirectional or unidirectional. In other scenarios, an attack on network 24 may comprise malicious traffic that masquerades as originating from a certain host 36. Such an attack may comprise an attempt to install malware 40 on a computer 28 in network 28, or any other suitable kind of attack.

In the embodiments described herein, a malware detection system 44 identifies hosts 36 that are associated with malicious traffic, such as hosts that control malware 40 and/or hosts that originate attacks on the protected network. Example methods for identifying malicious hosts are described below.

In an embodiment, malware detection system 44 comprises an interface 48 for connecting to network 24 and/or network 28, and a processor 52 that carries out the malicious host detection techniques described herein. Interface 48 may comprise, for example, a network probe, or any other suitable network interface. In some embodiments, the functions of processor 52 are partitioned among multiple processors (e.g., servers) in a distributed configuration that enables high scalability.

The configurations of system 20 and system 44 shown in FIG. 1 are example configurations, which are chosen purely for the sake of conceptual clarity. In alternative embodiments, any other suitable configuration of system and/or system 44 can be used. For example, in the example of FIG. 1 system 44 is placed between network 24 and WAN 32, such that the traffic between the two networks passes through system 44. In alternative embodiments, system 44 may comprise a node in network 24 that is provided with network traffic for monitoring, but without having the network traffic pass through it.

Some elements of system 44 may be implemented in hardware, e.g., in one or more Application-Specific Integrated Circuits (ASICs), Field-Programmable Gate Arrays (FPGAs) or network processors. Additionally or alternatively, some elements of system 44 can be implemented using software, or using a combination of hardware and software elements.

Some of the functions of system 44, such as the functions of processor 52, may be carried out using one or more general-purpose processors (e.g., servers), which are programmed in software to carry out the functions described herein. The software may be downloaded to the processors in electronic form, over a network, for example, or it may, alternatively or additionally, be provided and/or stored on non-transitory tangible media, such as magnetic, optical, or electronic memory.

### Malicious Host Detection Techniques

In some embodiments, system 44 identifies a malicious host by detecting a mismatch between the host name and a network address that is indicated in the network communication as allegedly associated with that host. In Hyper-Text Transfer Protocol (HTTP) request-response transactions, for example, each HTTP request and response indicates the host name and the host IP address, and system 44 looks for discrepancies between host names and IP addresses.

Generally, the disclosed techniques can be used with various other suitable types of communication transactions and network addresses, such as with the Simple Mail Transfer Protocol (SMTP). The description that follows, however, focuses on HTTP and IP addresses for the sake of clarity.

If a transaction indicates a host IP address that is not genuinely associated with the host name, there is high likelihood that the transaction is malicious. For example, some types of malware attempt to circumvent malware protection systems by indicating a host name that is well known and trusted. As another example, some types of malware alternate between IP addresses in order to avoid detection. In both cases, the IP address indicated in the traffic is likely not to match the host name.

In some embodiments, system 44 monitors communication traffic (e.g., HTTP transactions) and attempts to find discrepancies between host names and host IP addresses indicated in the monitored traffic.

Processor 52 in system 44 may use various techniques for verifying whether the host IP address found in the traffic (referred to as “alleged IP address”) and the host name found in the traffic are genuinely associated with one another.

In some embodiments, processor 52 detects deviations from the normal expected flow of the address resolution process conducted by computers in the network. In a typical DNS process, for example, a client computer that intends to communicate with a host sends a DNS request to a DNS server with the required host name. The DNS server replies with a DNS response that returns the IP address of the host. The client is then able to communicate with the host using the IP address returned in the DNS response.

In some embodiments, upon receiving a transaction suspected of being malicious, processor 52 searches the network traffic for messages of the address resolution process that preceded this transaction. For example, processor 52 may search for a DNS request and DNS response that provided the IP address indicated in the transaction. Note that such messages may be found a long period of time before the alert or transaction, possibly on the order of hours.

If no previous messages are found, or if the identified messages indicate a different IP address, or if processor 52 finds any other suitable deviation from the expected address resolution process, system 44 decides that the transaction is malicious.

Note that, in order to detect absence of a DNS request, processor 52 should typically look for DNS requests over a long time period (e.g., a day) so as to account for possible local DNS caching. In an alternative embodiment, processor 52 may avoid this requirement by blocking the first connection to any site for which a DNS request was not observed over a predefined period (e.g., a day). Such a mechanism will typically force the client to refresh its local DNS cache.

As another example, processor 52 may verify whether the host name and the alleged IP address in the transaction belong to the same Autonomous System (AS). If not, the processor concludes that the host is malicious.

As yet another example, processor 52 may attempt to correlate the host name with the alleged IP address on the basis of geographical location. In these embodiments, the geographical location of the host is known to some extent. Processor 52 estimates the geographical location of the alleged IP address, and compares it with the known location of the host. If the two locations differ considerably, processor 52 concludes that the host is malicious. Processor 52 may estimate the location of the alleged IP address using various means, e.g., using IP geo-location techniques.

Further alternatively, system 44 may use any other suitable method for verifying whether the alleged IP address in the alert or transaction is genuinely associated with the host name.

In alternative embodiments, system 44 is triggered by an alert regarding communication traffic that is suspected of being malicious. The alert typically indicates a host name and an alleged IP address, which system 44 checks for consistency. Alerts of this sort may be generated, for example, by a C&C communication detection system that suspects the communication traffic of being C&C communication between malware and it controlling host. Alerts may also be generated, for example, by Intrusion Detection Systems (IDSs), firewalls, or any other suitable systems. Any of the disclosed mismatch detection techniques, which were described above as being applied to general network traffic, can be similarly applied to alerts. A scheme of this sort helps to reduce the number of false-positives, i.e., false detections of malicious hosts that are in fact innocent.

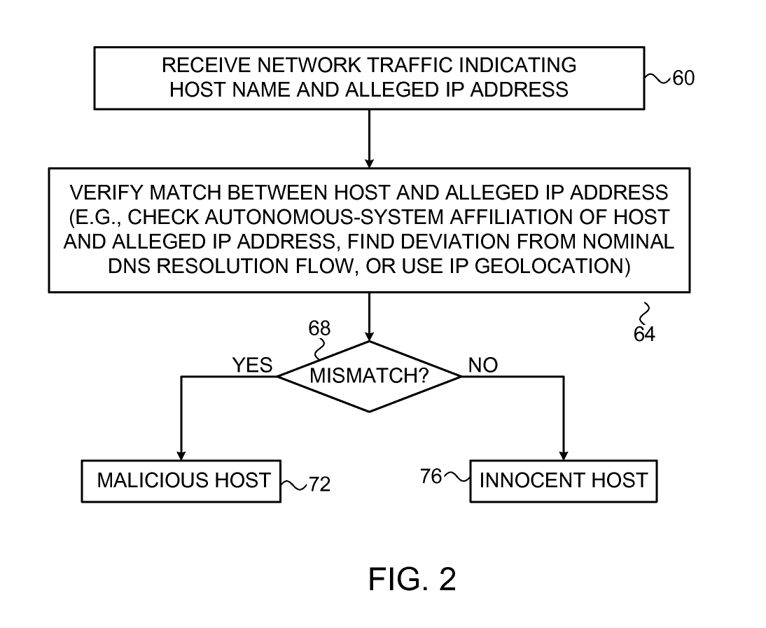

FIG. 2 is a flow chart that schematically illustrates a method for detecting malicious hosts. The method begins with system 44 receiving via interface 48 a network transaction, at an input step 60. The transaction indicates a host name and a respective alleged IP address.

Processor 52 in system 44 verifies whether the host name and alleged IP address match, at a matching step 64. Any of the verification methods described above can be used for this purpose. If the host name and the alleged IP address do not match, as checked at a checking step 68, processor 52 concludes that the host is malicious, at a malicious detection step 72. System 44 may, for example, output an alarm to an operator or take any other suitable action. If checking step 68 indicates that the host name and the alleged IP address match, processor 52 concludes that the host is innocent, at an innocent detection step 76.

In some embodiments (either in addition to or instead of steps 68-72) processor 52 calculates and outputs a quantitative score that indicates the probability that the host is malicious. This score can be used for declaring the host as malicious or innocent, either alone or in combination with other inputs or indications.

Although the embodiments described herein mainly address detection of malicious hosts, the principles of the present disclosure can also be used for other applications, such as network health monitoring systems and network configuration management systems.

It will thus be appreciated that the embodiments described above are cited by way of example, and that the present disclosure is not limited to what has been particularly shown and described hereinabove. Rather, the scope of the present disclosure includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method, comprising:
receiving network communication, which indicates a name of a host and an alleged network address of the host;
verifying whether the alleged network address is genuinely associated with the host; and
in response to detecting that the alleged network address is not genuinely associated with the host, deciding that the network communication associated with the host is malicious.

2. The method according to claim 1, wherein deciding that the network communication is malicious comprises assigning to the host a respective quantitative score that is indicative of a probability that the host is malicious.

3. The method according to claim 1, wherein receiving the network communication comprises receiving a request-response transaction that comprises the name and the alleged network address of the host.

4. The method according to claim 1, wherein receiving the network communication comprises receiving an alert that suspects the host is malicious, and wherein deciding that the network communication associated with the host is malicious comprises reaffirming the alert.

5. The method according to claim 1, wherein the network address comprises an Internet Protocol (IP) address.

6. The method according to claim 1, wherein verifying whether the alleged network address is associated with the host comprises checking whether the host and the alleged network address belong to a same Autonomous System (AS).

7. The method according to claim 1, wherein verifying whether the alleged network address is associated with the host comprises estimating a first geographical location of the alleged network address and comparing the first geographical location with a second geographical location of the host.

8. The method according to claim 1, wherein verifying whether the alleged network address is associated with the host comprises detecting a deviation from an expected flow of an address resolution process for the host.

9. The method according to claim 1, wherein deciding that the network communication associated with the host is malicious comprises outputting an alert to an operator.

10. Apparatus, comprising:
an interface, which is configured to receive network communication that indicates a name of a host and an alleged network address of the host; and
a processor, which is configured to verify whether the alleged network address is genuinely associated with the host, and, in response to detecting that the alleged network address is not genuinely associated with the host, to decide that the network communication associated with the host is malicious.

11. The apparatus according to claim 10, wherein the processor is configured to assign to the host a respective quantitative score that is indicative of a probability that the host is malicious.

12. The apparatus according to claim 10, wherein the network communication comprises a request-response transaction that comprises the name and the alleged network address of the host.

13. The apparatus according to claim 10, wherein the interface is configured to receive an alert that suspects the host is malicious, and wherein the processor is configured to reaffirm the alert by deciding that the network communication associated with the host is malicious.

14. The apparatus according to claim 10, wherein the network address comprises an Internet Protocol (IP) address.

15. The apparatus according to claim 9, wherein the processor is configured to verify whether the alleged network address is associated with the host by checking whether the host and the alleged network address belong to a same Autonomous System (AS).

16. The apparatus according to claim 10, wherein the processor is configured to verify whether the alleged network address is associated with the host by estimating a first geographical location of the alleged network address and comparing the first geographical location with a second geographical location of the host.

17. The apparatus according to claim 10, wherein the processor is configured to verify whether the alleged network address is associated with the host by detecting a deviation from an expected flow of an address resolution process for the host.

18. The apparatus according to claim 10, wherein, upon deciding that the network communication associated with the host is malicious, the processor is configured to output an alert to an operator.
